(19) United States
(12) Patent Application Publication
(10) Pub. No.: US 2011/0315874 A1
(43) Pub. Date: Dec. 29, 2011

(54) Mass Spectrometer

(75) Inventors: Masahiro Ikegami, Kyoto-shi (JP); Kiyoshi Ogawa, Kyoto-shi (JP); Takahiro Harada, Kyoto-shi (JP)

(73) Assignee: SHIMADZU CORPORATION, Kyoto-shi, Kyoto (JP)

(21) Appl. No.: 13/254,136

(22) PCT Filed: Mar. 5, 2009
(86) PCT No.: PCT/JP2009/000996

§ 371 Date: Aug. 31, 2011

(51) Int. Cl. H01J 49/26

(52) U.S. Cl. 250/288

(57) ABSTRACT

When specimen (4) is placed on specimen stage (2), controller (32)—via the stage driver (33) and drive mechanism (6)—moves the specimen stage (2) by a predetermined step pitch according to the magnification factor in the X-direction and the Y-direction, and the image pickup unit (7) acquires a microscopic observation image of the specimen (4) after each move. The microscopic observation image that is acquired and the position data of the specimen stage (2) when the image is acquired are stored in memory (321). When a plurality of microscopic observation images of the areas that are adjacent on the specimen (2) are obtained, the image integration processor (322) uses the position data to join the microscopic observation images. When a plurality of microscopic observation images that encompasses the entirety of the specimen (2) is all joined together to form a specimen observation image, the specimen observation image is displayed on a display unit 37. The user then specifies the desired measurement region based on the specimen observation image that is high in spatial resolution and covering a wide area. Because of this, there is no need to repeat the steps of image pickup and mass spectrometry even when performing a mass spectrometry over a wide area, allowing an efficient measurement.

### TECHNICAL FIELD

The present invention relates to mass spectrometers and, in particular, to mass spectrometers referred to as mass microscopes or imaging mass spectrometers which are capable of performing mass spectrometry on a two-dimensional region of a specimen.

### BACKGROUND ART

Apparatuses referred to as mass microscope and imaging mass spectrometer have been developed to observe the morphology of specimens such as biological tissues and, at the same time, measure the distribution of molecules that are present in a predetermined region of the specimen (see Patent Literature 1 through 3 and Non-Patent Literature 1 and 2). With these apparatuses, without crushing or pulverizing a specimen as required previously and hence while substantially preserving the morphology of the specimen, an image showing the distribution of ions having a specific mass (more precisely, having a specific mass/charge ratio, m/z) present in an optional area that is specified on the specimen by microscopic observation can be obtained, i.e., an image is obtained. It is hoped that these apparatuses can be used in fields such as biochemistry, medicine and pharmacology in applications such as obtaining the distribution data of proteins and the like that are included in an biological cell.

For example, with the mass microscope that is described in Non-Patent Literature 1 and 2, the position on the surface of a specimen that is observed with a long-focal length microscope and the ionization position where a very small area on a specimen is irradiated with a laser light for the ionization of the specimen components are separately located within the same sealed chamber. And, a specimen stage on which the specimen is placed is allowed to move between the observation position and the ionization position. The measurement procedure involves the user setting a specimen (e.g., a piece of biological tissue that is excised from a biological tissue) on a specimen stage and obtaining an enlarged observation image of the surface of the specimen obtained with a microscope of the observation position.

Since the magnification factor of the microscope is variable and the observed range on the specimen is also movable, the user can select a magnification factor of his liking to observe an image of any optional site of the specimen.

The user views the observed image of the specimen that is shown on the monitor screen to specify the desired measurement region for mass spectrometry. The measurement region can be either a spot (a point) or a two-dimensional region. After the measurement region is specified and the user specifies that the analysis be executed, the specimen stage is moved to the ionization position where mass spectrometry is performed on the measurement region. To perform mass spectrometry on a two-dimensional measurement region, the specimen stage is moved so that the irradiation position of a laser beam that is narrowed to a very small diameter scans (e.g., raster scan) over the measurement region. Mass spectrometry on other very small regions is sequentially executed to collect mass spectrum data for each very small region. Subsequently, intensity information of specific mass is mapped to prepare mass spectrometry images.

In a mass microscope such as the afore-described, to observe a very small site on a specimen, the magnification factor of the microscope has to be increased. When the magnification factor of the microscope is increased, the area of what is observed on the specimen, i.e., the observation field is narrowed. With previous mass microscopes, since the measurement region where mass spectrometry is performed has to be set to be within the observation field, the measurement region where an imaging mass spectrometry can be performed becomes narrower as the magnification factor is increased to observe color, patterns and the like of a very small site.

With the analysis of biological tissues, in particular, specimens such as organs, it is often the case that the region desired for the analysis falls outside the observation field of the microscope. With previous mass microscopes, it is not possible to precisely analyze in a single pass a region that extends beyond the observation field of a microscope and obtain a mass spectrometry image, When a measurement of that sort is required, the steps of specifying a measurement region on a microscopic observation image that is obtained with a microscope using a high magnification factor and then performing mass spectrometry on the specified measurement region have to be repeated multiple times while incrementally moving the specimen and shifting the observation field. This process is very labor-intensive and time-consuming.

Furthermore, when working with biological specimens, if the measurement time becomes protracted, the specimen itself may undergo changes in its dynamic behavior or metamorphose and may hamper an accurate analysis. Furthermore, with the afore-described method involving the repetition of microscopic observation and mass spectrometry, there is no guarantee for the continuity or the precision of the positional relationship between a measurement region that is present on a specimen and other measurement regions that are supposed to be adjacent to it. For this reason, any attempt to obtain a mass spectrometry image that extends over a large area of a specimen may result in areas that are not analyzed or joints between images of adjacent measurement regions that are not correctly aligned.
Patent Literature 1: Laid-Open Patent Application Publication No. 2007-66533
Patent Literature 2: Laid-Open Patent Application Publication No. 2007-157353
Patent Literature 3: Laid-Open Patent Application Publication No. 2007-257851
Non-Patent Literature 1: Kiyoshi Ogawa and 5 others, “Mass Microscope Development,” Shimadzu Review, Shimadzu Corporation, Mar. 31, 2004, Vol. 62, No. 3 and 4, p. 125-135
Non-Patent Literature 2: Takahara Harada and 8 others, “Analysis of Biological Tissues with Mass Microscope,” Shimadzu Review, Shimadzu Corporation, Apr. 24, 2008, Vol. 64, No. 3 and 4, p. 139-146

### DISCLOSURE OF THE INVENTION

### Problems to Be Solved by the Invention

The present invention was made in light of the afore-described problems, and it is the object of the present invention to provide a mass spectrometer that is capable of performing imaging mass spectrometry efficiently over an area that extends beyond the observation field of microscopic observation unit.

### Means for Solving the Problems

The mass spectrometer according to the present invention for solving the afore-described problems includes:

a) a microscopic observation means for acquiring microscopic observation images of a two-dimensional region on a specimen;

b) a moving means for moving either or both the specimen or the microscopic observation means so as to move the position of the two-dimensional region on the specimen;

c) an image capturing control means for controlling the microscopic observation means and the moving means so that the microscopic observation means acquires microscopic observation images whenever the relative position of the specimen and the microscopic observation means is changed by the moving means;

d) an image forming means for forming and displaying on a display screen a specimen observation image for a region that is larger than each microscopic observation image by joining a plurality of microscopic observation images that correspond to different two-dimensional regions that are acquired under the control of the image capturing control means;

e) a specifying means for allowing a user to specify a desired measurement region in a specimen observation image that is displayed by the image forming means; and

f) a mass spectrometry means including: an ionization means for ionizing components that are present in a very small region on the specimen; a mass separation and detection means for separating and detecting ions that are generated according to mass/charge ratio; a position scanning means for two-dimensionally scanning the position of the very small regions on the specimen; and an analysis control means for controlling the ionization means, mass separation and detection means and position scanning means so as to perform a two-dimensional mass spectrometry in a measurement region specified by the specifying means.

With the mass spectrometer according to the present invention, the ionization means typically irradiates a laser beam of a very small diameter to perform ionization using the MALDI method. However, various laser dissociation ionization (LDI) methods may be used other than MALDI. Ionization methods that do not use a laser beam may be used such as dissociation electrospray ionization (DESI), secondary ion mass spectrometry and the like.

With the mass spectrometer according to the present invention, when a person taking the measurement (the user) sets a specimen to be analyzed on the specimen stage, the image capturing control means controls the moving means so as to change the relative position of the specimen and the microscopic observation means. Every time the relative position moves by a predetermined step pitch, the microscopic observation means acquires a microscopic observation image of a two-dimensional region on the specimen. Ordinarily, the step pitch is set so that no gap is formed between adjacent microscopic observation regions on the specimen or so that there is a slight overlap between the microscopic observation regions. Increasing the magnification factor reduces the size of the observation field but increases the spatial resolution of the microscopic observation image. Even though the size of the observation field of a single microscopic observation image is reduced, by capturing microscopic observation images while changing the relative position of the specimen and the microscopic observation means as afore-described, a plurality of microscopic observation images of a high spatial resolution are obtained, covering, for example, the entirety or nearly the entirety of the specimen.

The image forming means joins the plurality of microscopic observation images that were obtained as afore-described, forms a specimen observation image of a high spatial resolution that covers the entire or nearly the entire specimen and displays the specimen observation image on a display screen. The microscopic observation images may be joined after all microscopic observation images have been obtained or may be joined after each new microscopic observation image is obtained. The user then specifies the desired measurement region on the specimen observation image that is displayed on the display screen. The measurement region may either be a single point (microscopic area), a one-dimensional area, or a two-dimensional area. At the largest, the entirety of the specimen observation image that is displayed may be specified as the measurement region.

Next, at the mass spectrometry means, the ionization means irradiates, for example, a laser light onto the measurement region. If a one-dimensional or a two-dimensional measurement region is specified, the position scanning means causes the irradiated position of the laser light to scan the measurement region. At the site where the laser light is irradiated, the components in the specimen are ionized, and the ions that are generated are led to the mass separation and detection means. With the mass separation and detection means, a variety of methods is available for separating the ions based on the mass/charge ratio (m/z). However, it is desirable to use a time-of-flight mass spectrometer to achieve a high mass resolution. In this way, a two-dimensional mass spectrometry is performed on a measurement region of any size that is specified on a specimen observation image of a high spatial resolution, i.e., mass spectrometry imaging is performed.

With one mode of a mass spectrometer according to the present invention, the moving means is a means for moving, with respect to the microscopic observation means whose position is fixed, a specimen stage that holds a specimen or upon which a specimen is placed. This mode further includes a position data acquisition means for acquiring position data of the specimen stage when microscopic observation images are acquired under the control of the image capturing control means, and the image forming means uses position data obtained by the position data acquisition means for each microscopic observation image when joining a plurality of microscopic observation images.

If the position of the two-dimensional region for microscopic observation changes due to the high-precision movement of the specimen stage and if, for example, the specimen stage moves along two axes (x-axis and y-axis) that are orthogonal to each other, the position data of the specimen stage can be identified by the coordinate positions along the two axes. Hence, by using the position data that is obtained corresponding to each microscopic observation image, the microscopic observation image can be joined with the adjacent microscopic observation images after correctly positioning them, performing a good joining process with no positional misalignment where the joining is done.

Furthermore, with the mass spectrometer of the afore-described mode, it is acceptable for the image forming means, in joining a plurality of microscopic observation images, to acquire and store specimen observation images and position data corresponding to said images. The mass spectrometer may further include a measurement position data acquisition means for acquiring and storing position data corresponding to the measurement region based on position data that is stored by the image forming means when a measurement region is specified by the specifying means; and the analysis control means may use position data stored by the measurement position data acquisition means to control the position scanning means so as to move the specimen stage and scan the position of a very small region that is to be ionized by the ionization means.

According to this configuration, because the position data that is acquired when the measurement point or a measurement region is specified is used during ionization by irradiation with a laser light that is focused to a very small diameter, ionization can be performed with a high positional accuracy when ionizing a desired measurement point or a very small region within a measurement region. This allows the measurement region specified by the user to precisely match the actual area that is subjected to mass spectrometry.

Incidentally, with the mass spectrometer according to the present invention, since a measurement region can be specified outside of the bounds of the microscopic observation image, it is acceptable to allow a plurality of measurement regions to be specified outside of the bounds of the microscopic observation image. Stated otherwise, the specifying means allows a plurality of measurement regions to be specified on the specimen observation image that is displayed. The analysis control means controls the ionization means, mass separation and detection means and position scanning means so as to obtain position data corresponding to each of the specified plurality of measurement regions and to perform mass spectrometry in each of the measurement regions based on said position data.

### Effects of the Invention

With a mass spectrometer according to the present invention, a measurement region to be subjected to mass spectrometry can be decided based on specimen observation images of a high spatial resolution and covering a region that is larger than microscopic observation images that are obtained by high-magnification factor microscopic observation. This means that even when performing a two-dimensional mass spectrometry on a large region on a specimen or on the entire specimen, there is no need to repeat the steps of setting the measurement region by microscopic observation and performing mass spectrometry, allowing mass spectrometry imaging over a large area to be performed efficiently, thus reducing labor and time required. Furthermore, since the mass spectrometry images that are divided and acquired need not be joined together, mass spectrometry images that are superior to previous ones are obtained.

### BRIEF DESCRIPTION OF THE FIGURES

FIG. 1 shows the overall configuration of one embodiment of a mass microscope according to the present invention.

FIG. 2 shows a flowchart that identifies the measurement procedure that is used with a mass microscope of the present embodiment.

FIG. 3 is a figure describing the specimen surface image creation process in the present embodiment of a mass microscope.

FIG. 4 is a figure describing the specimen surface image creation process in the present embodiment of a mass microscope.

FIG. 5 describes the measurement operation in the present embodiment of a mass microscope.

### DESCRIPTION OF THE NUMERICAL REFERENCES

1. Sealed chamber
2. Specimen stage
3. Specimen plate
4. Specimen
5. Guide
6. Drive mechanism
7. Image pickup unit
8. Transmission illumination unit
10. Laser light irradiation unit
11. Laser focusing optical system
20. Vacuum chamber
21. Vacuum pump
22. Ion transportation tube
23, 24. Ion transportation optical system
25. Ion trap
26. Time-of-flight mass spectrometer
27. Detector
30. Data processor
31. Analysis controller
32. Controller
321. Microscopic observation image/position data memory
322. Image integration processor
323. Specimen image/position data memory
33. Stage driver
34. Image processor
35. Laser driver
36. Operation unit
37. Display unit

### BEST MODE FOR PRACTICING THE INVENTION

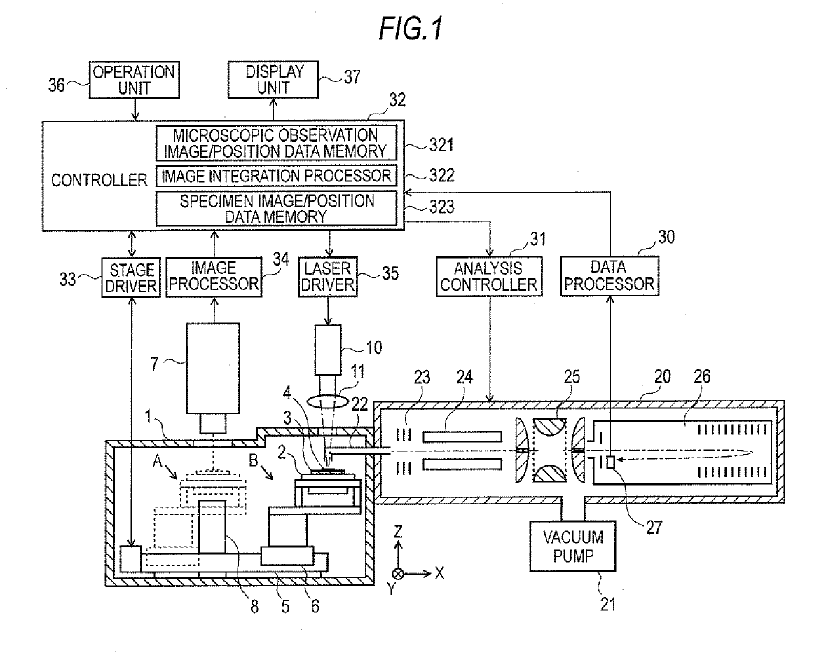

As one embodiment of a mass spectrometer according to the present invention, a mass microscope is described next with reference to FIGS. 1 through 5. FIG. 1 shows the overall configuration of the present embodiment as a mass microscope.

The mass microscope has a sealed chamber 1 whose internals are maintained substantially at atmospheric pressure, a vacuum chamber 20 whose internal atmosphere is kept at a high level of vacuum by means of a vacuum pump 21 such as a turbo molecular pump. Disposed within the sealed chamber 1 is specimen stage 2 which holds specimen plate 3 upon which specimen 4 is placed. A drive mechanism 6 that includes a motor and the like can drive the specimen stage 2 in a sliding reciprocal motion that covers a large distance in the X-direction along guide 5. In FIG. 1, the position where specimen stage 2 is depicted with the solid lines is identified as analysis position B. Where the position is identified by dotted lines shows observation position A. In addition to the movement in the X-direction along guide 5, the drive mechanism 6 can move—within a predetermined range —the specimen stage 2 in the Y-direction running orthogonally to the X-direction in the horizontal plane and also in the Z-direction—the height direction.

An image pickup unit 7 comprising such components as a CCD camera and lens is disposed above observation position A outside the sealed chamber 1. A transmission illumination unit 8 is disposed within the sealed chamber 1 to oppose the image pickup unit 7. When the specimen stage 2 is located at observation position A, light that is emitted by the transmissive illumination unit 8 passes through an opening that is formed in the specimen stage 2 and becomes incident to the lower surface of the specimen 4 so that the specimen image created by the transmissive light can be observed by the image pickup unit 7. The magnification factor used in the microscopic observation by the image pickup unit 7 is variable over a predetermined range. Increasing the magnification factor allows the surface of the specimen 4 to be more finely observed but also narrows the observable range, i.e., the observation field. The image signal that is acquired by the image pickup unit 7 is sent to the image processor 34 where image processing is performed. A two-dimensional image that is displayable on a display unit 37—further described below—is formed by the image processor 34. Needless to say, illumination suited for reflection observation or fluorescent observation may also be separately provided in addition to the illumination required for transmissive observation.

Disposed above the analysis position B outside of the sealed chamber 1 are a laser light irradiation unit 10 and a laser focusing optical system 11 required for irradiating the surface of specimen 4 with a laser light that is focused to a very small diameter. Also, disposed within the sealed chamber 1 to oppose the specimen 4 is an ion collection opening of ion transportation tube 22 whose purpose is to transport to vacuum chamber 20 the ions that are generated from specimen 4 in accordance with the irradiation with the laser light.

Disposed within the vacuum chamber 20 are: ion transportation optical systems 23 and 24 which converge the ions and send the ions to the later stages; ion trap 25 which temporarily holds the ions; a reflectron-type time-of-flight mass spectrometer 26 which separates the ions based on mass/charge ratio (m/z); and a detector 27 which detects the ions that have been separated by the time-of-flight mass spectrometer 26. In addition to simply holding the ions, the ion trap 25 is capable of selecting as precursor ions those ions having a specific mass/charge ratio among the variety of ions that are introduced to it and to generate product ions by cleaving the precursor ions by collision-induced dissociation. In other words, this mass microscope has the capability to perform MS/MS analysis or MSn analysis in addition to ordinary mass spectrometry (which does not entail any cleaving).

The detection signal from the detector 27 is input to data processor 30 where the time-of-flight of each ion is converted to a mass/charge ratio to create a mass spectrum. Furthermore, based on the mass spectra that are obtained from each of the different measurement points in the measurement region, an image and the like representing the distribution of ions having specific mass/charge ratios is prepared.

Controller 32—which controls the overall mass microscope—controls the operation of the mass spectrometry unit including the ion trap 25 via analysis controller 31, controls the movement of the specimen stage 2 via the drive mechanism 6 and the stage driver 33, and controls the emission of laser light from laser light irradiation unit 10 via laser driver 35. Also connected to the controller 32 are an operation unit 36 where user operations and instructions are entered and a display unit 37 for displaying such things as two-dimensional observation images and two-dimensional substance distribution images of specimen 4.

As functional blocks, the controller 32 includes: microscopic observation image/position data storage unit 321 which stores the microscopic observation images and their corresponding position data that are acquired from image processor 34; image integration processor 322 for performing joining process on microscopic observation images; and specimen image/position data storage unit 323 for storing specimen observation images that have been joined by image integration processor 322 and their corresponding position data.

At least some of the functionalities of the controller 32, analysis controller 31 and data processor 30 can be realized by the execution of dedicated software that is installed on a personal computer.

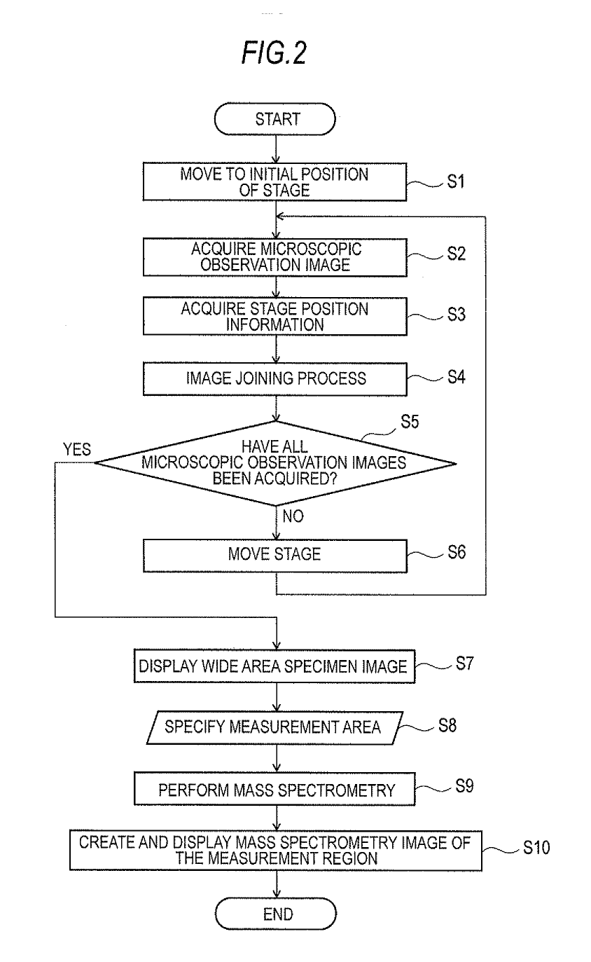

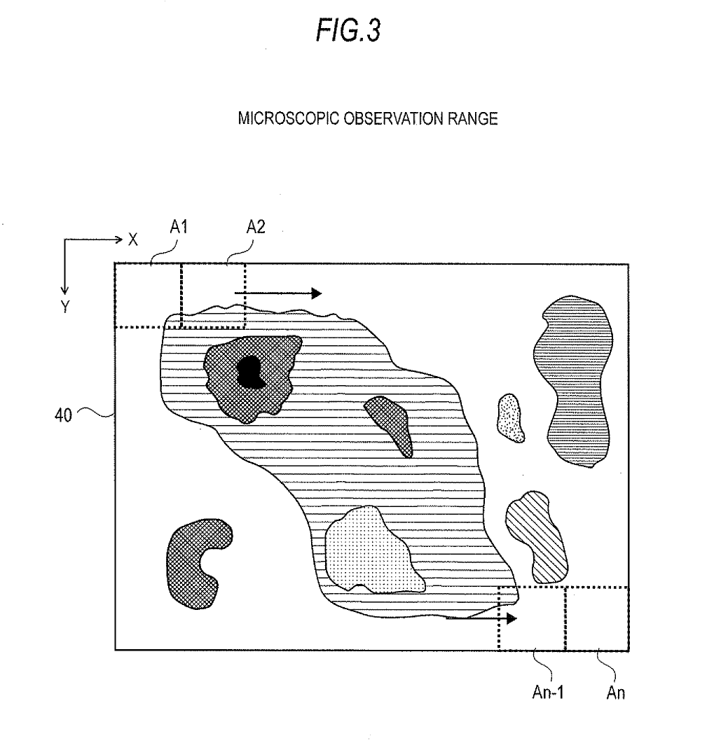

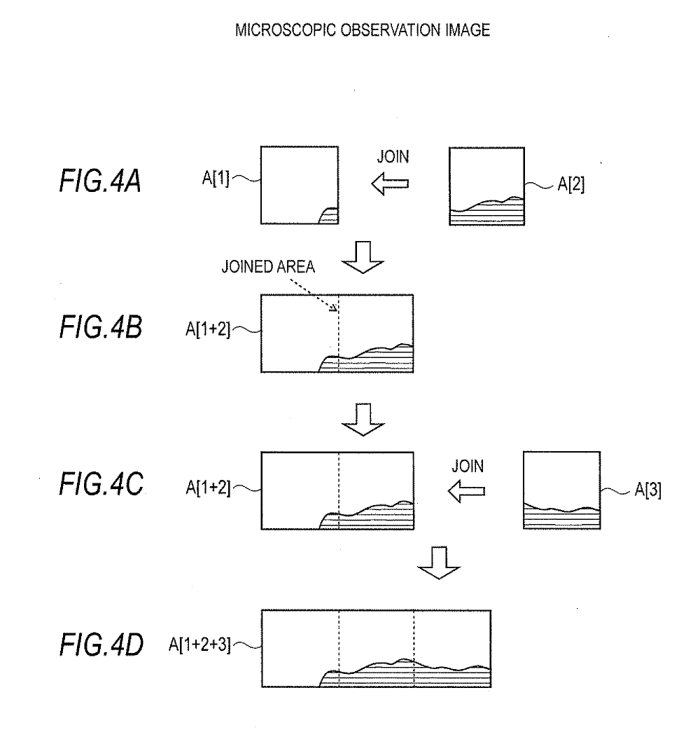

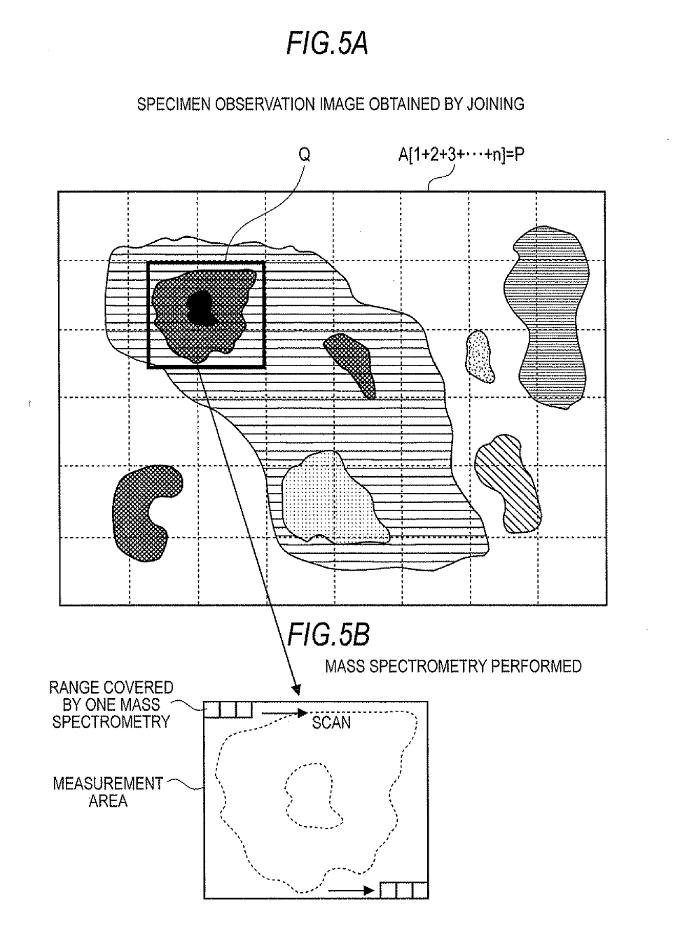

One example of a measurement procedure using a mass microscope according to the present embodiment is described next with reference to FIGS. 2 through 5. FIG. 2 shows a flowchart depicting the measurement procedure. FIG. 3 and FIG. 4 show the process involved in the preparation of the surface image of a specimen. FIG. 5 shows the procedure involved in a measurement operation.

The first thing the user does is to set on the specimen stage 2 a specimen plate 3 carrying the specimen 4 to be measured. When the user instructs from the operation unit 36 to start the execution of the observation, the controller 32 which receives this instruction operates the drive mechanism 6 via the stage driver 33 and causes the specimen stage 2 to move to the initial position, i.e., observation position A (step S1). If the maximum range where specimen 4 can be placed on the specimen plate 3 is identified by 40 in FIG. 3, the microscopic observation range A1 located within range 40 is set as the initial position for which an image can be captured.

When the specimen stage 2 arrives at the predetermined position, the image pickup unit 7 sets a predetermined magnification factor (i.e., a magnification factor required to capture microscopic observation range A1), focuses on specimen 4, and captures the surface image of specimen 4. When the image is captured, a microscopic observation image A[1] in microscopic observation range A1 on specimen 4 is formed by image processor 34. The controller 32 then acquires the microscopic observation image A[1] (step S2). Furthermore, since the position data for the microscopic observation image A[1] is obtained as the position coordinates of the specimen stage 2 in the X-direction and Y-direction, the controller 32 acquires the position data via stage driver 33 (step S3). At the controller 32, the image data constituting the microscopic observation image A[1] and its corresponding position data are stored in the microscopic observation image/position data storage unit 321. In respect to the position data, the (X, Y) coordinates of the reference position of the specimen stage 2 can be set to, for example, (0, 0), and the position data of any one microscopic observation image can be represented within the coordinates range in the X- and Y-directions.

When the first microscopic observation image is obtained by the controller 32, the processes that are performed in steps S4 and S5 are bypassed. The drive mechanism 6 is operated via stage driver 33 and the specimen stage 2 is moved to the next microscopic observation range following the previous microscopic observation range (step S6). To explain, as shown in FIG. 3, after the image of microscopic observation range A1 is captured, specimen stage 2 is moved in a stepwise manner to the position where the image of microscopic observation range A2 is captured. Just as in capturing an image of microscopic observation range A1, the image pickup unit 7 uses a predetermined magnification factor, focuses on the surface of specimen 4 and captures a surface image of specimen 4. The controller 32 acquires microscopic observation image A[2] and its corresponding position data. If a previously captured microscopic observation image (or an image earlier formed by joining a plurality of microscopic observation images) already exists, the image integration processor 322 within controller 32 executes a process whereby the position data is used to join the new microscopic observation image with the microscopic observation image already obtained (step S4). For example, as FIG. 4(a) shows, when microscopic observation image A[2] is obtained when microscopic observation image A[1] is already acquired, the two are joined to create a joined image A[1+2] shown in FIG. 4(b).

In the example shown in FIG. 3, the step pitch that is used for moving the specimen stage 2 after capturing the image of microscopic observation range A1 is the same size as the size of microscopic observation range A1 in the X-direction. However, it is also possible to use a step pitch that is smaller than the size of microscopic observation range A1 in the X-direction to obtain a microscopic observation image with an overlapping edge. Needless to say, when the microscopic observation images are joined, the overlapping portions are suitably processed so that the two microscopic observation images are smoothly joined.

The controller 32 then makes a decision as to whether or not all microscopic observation images have been acquired (step S5). If not all microscopic observation images have been acquired, the process moves on to step S6 where, as afore-described, the specimen stage 2 is moved to the next microscopic observation position and an image is captured. The microscopic observation image that is captured is joined to the images that have already been joined. This process is automatically repeated. For example, as FIG. 4(c) shows, when joined image A[1+2] already exists, if microscopic observation image A[3] which is adjacent to joined image A[1+2] is acquired, the two are joined to create joined image A[1+2+3] shown in FIG. 4(d).

By repeating the afore-described processes, microscopic observation images with a high spatial resolution are successively joined, and when the acquisition of all microscopic observation images is finally completed, a specimen observation image P such as that shown in FIG. 5 covering the entire area of the specimen that can be carried on the specimen plate 3 is obtained. This image and its corresponding position data are stored in the specimen image/position data storage unit 323. The controller 32 displays this wide range specimen observation image P on the screen of the display unit 37 (step S7). There is a precise correspondence between the position on the high-resolution specimen observation image P and the coordinate position of the specimen stage 2, and this correspondence relationship is also stored in the specimen image/position data storage unit 323.

The user observes the specimen observation image P that is displayed on the screen of the display unit 37 and specifies a selected measurement region to be analyzed using the operation unit 36 (step S8). This can be done, for example, by moving a cursor to a desired part on the specimen observation image P that is displayed on the display unit 37 and performing some clicking operation, or by enclosing a predetermined area to specify the measurement region. For example, with the example shown in FIG. 5, the operation unit 36 is operated to freely set and change the size, shape and position of the measurement region specifying frame Q to enclose the desired measurement region.

With the example shown in FIG. 5, the portion of the high-resolution microscopic observation image that can be observed in real-time is the small rectangular shaped regions that are bounded by the dotted lines formed in a grid-pattern. However, with this mass microscope, the measurement region that is specified can be of any size or position and may straddle or exceed a single rectangular-shaped region. At the largest, the entire specimen observation image P may be specified as the measurement range. Alternatively, a small measurement range that fits within a single microscopic observation image may be specified, or even a single point may be specified as the measurement range. It is desirable for the controller 32 to have the functionalities that use the image data that is stored in the specimen image/position data storage unit 323 to allow any portion of the specimen observation image P to be enlarged and displayed using any magnification factor.

When the measurement range is specified, the controller 32 acquires the position data corresponding to the measurement range from memory 323. The controller 32 performs a two-dimensional mass spectrometry on the specified measurement region (step S9). To explain, the specimen stage 2 is moved from observation position A to analysis position B via the operation of stage driver 33 and drive mechanism 6. The controller 32 then finely adjusts the position of the specimen stage 2 in the X- and Y-directions so that the laser light is irradiated upon the coordinate position that was stored in advance of the first measurement point in the measurement region. At the same time, adjustments are made in the Z-direction so that the height is optimum. A laser light is emitted for a short duration from the laser light irradiation unit 10 via the laser driver 35 so as to irradiate the laser light onto the targeted measurement point on the specimen 4.

The irradiation with the laser light causes ionization of the components in the specimen 4. The ions that are generated are drawn by suction into the ion collection opening of the ion transportation tube 22 and passes through the ion transportation tube 22 into the vacuum chamber 20. The ions pass through the ion transportation optical systems 23, 24 and are led to an ion trap 25 where operations such as cooling are temporarily performed to be followed by the imparting of kinetic energy to all ions almost at the same time. The ions are then sent to the time-of-flight mass spectrometer 26. Ordinarily, with a LDI, the amount of ions that is generated by one irradiation of a laser light is not that numerous and, furthermore, may vary largely. For this reason, laser light is irradiated a plurality of times as pulses onto the same measurement point. The ions that are generated are from each irradiation are temporarily stored in ion trap 25 and are collectively subjected to mass spectrometry by a time-of-flight mass spectrometer 26.

The ions are released all at once from the ion trap 25 and are separated according to mass/charge ratio during their flight through the time-of-flight mass spectrometer 26 and arrive at detector 27 at different times. The detector 27 outputs a detection signal according to the amount of incident ions, and the detection signal is input to the data processor 30. Since the time-of-flight of each ion depends on the mass/charge ratio, the data processor 30 converts the time-of-flight into a mass/charge ratio and creates a mass spectrum.

When mass spectrometry on one measurement point in a measurement region is completed, the controller 32 controls the drive mechanism 6 via the stage driver 33 so that the irradiation position of the laser light moves to the next measurement point within the measurement region. To explain, as shown in FIG. 5(b), the drive mechanism 6 is Controlled via the stage driver 33 so as to sequentially move in the X-direction and Y-direction within the measurement region using a predetermined step pitch. Every time that the measurement point moves, the laser light is irradiated, and ions are generated and mass spectrometry is performed on those ions. While scanning the irradiation position of the laser light in this manner, mass spectrometry is performed as afore-described, resulting in the data processor 30 to create a mass spectrum at each measurement point. Based on the mass spectrum, qualitative and quantitative analyses are performed to identify the substances or to obtain an estimation of the amounts contained.

When performing a two-dimensional mass spectrometry on a predetermined measurement region on a specimen 4, a signal whose strength corresponds to a specific mass/charge ratio is determined every time that the laser irradiation position is scanned as afore-described, and the signal strength is converted to a two-dimensional image to create a distribution image of specific substances. The controller 32 displays the mass spectrometry result that is obtained in this way on the screen of the display unit 37 (step S10). When the mass spectrometry on the specified measurement point or measurement region is completed, the controller 32 returns the specimen stage 2 to observation point A by the operation of the stage driver 33, and this completes the series of measurements.

As afore-described, with the present embodiment of the mass microscope, by joining high-resolution microscopic observation images and creating a specimen observation image extending over a wide range, the measurement region to be subjected to mass spectrometry can be specified to be an image whose observation field extends beyond the observation field that is observed in real-time.

Even though, in the afore-described embodiment, the ionization method was LDI which does not use a matrix, it is also possible to use MALDI as the ionization method. Furthermore, a variety of other ionization methods can be used such as DESI and ELDI.

In the ease of a MALDI, a matrix must be attached to the surface of the specimen before mass spectrometry is performed. This means that a means has to be separately provided that allows the user to set the specimen on the specimen stage after the matrix is applied or sprayed onto the surface of the specimen, or a means to apply or spray a matrix onto a specimen that is already set on the specimen stage. With the latter, since the image of the surface of the specimen prior to a matrix is formed can be imaged and a measurement region can be decided based on a high-resolution clear image, a mass spectrometry imaging can be accurately performed on the region targeted by the user.

With the mass microscope according to the afore-described embodiment, the analysis position B is positioned within the sealed chamber 1 so that ionization can be performed in an atmospheric pressure. However, if ionization is to be performed in a vacuum atmosphere, the analysis position b is positioned within the vacuum chamber 20. Also, with the mass microscope according to the afore-described embodiment, observation position A and analysis position B were made different and the specimen stage 2 was made to be movable between positions A and B. However, it is also possible to share observation position A and analysis position B.

To explain, as described in Non-Patent Literature 3, what is required is to irradiate the specimen that is placed on the specimen stage with an ionization laser light that is directed from obliquely above and to position the image pickup unit at a location obliquely above so that the surface image of the specimen is acquired when the specimen is in the same condition.

Furthermore, it is also possible to move the image pickup unit instead of moving the specimen stage to obtain microscopic images while shifting the observation positions on the specimen. However, since, ordinarily, the specimen stage is constructed to be movable so that two-dimensional mass spectrometry can be performed, it is more practical to change the relative positions of the two by fixing the position of the image pickup unit and moving the specimen stage.

The afore-described embodiments are only examples of the present invention, and needless to say, various modifications, corrections and additions can be suitably made within the scope of the present invention and without deviating from the scope of the claims.

1. A mass spectrometer comprising:
a) a microscopic observation means for acquiring microscopic observation images of a two-dimensional region on a specimen;
b) a moving means for moving either or both of the specimen or the microscopic observation means so as to move the position of said two-dimensional region on the specimen;
c) an image capturing control means for controlling said microscopic observation means and said moving means so that said microscopic observation means acquires microscopic observation images whenever the relative position of the specimen and the microscopic observation means is changed by said moving means;
d) an image forming means for forming and displaying on a display screen a specimen observation image for a region that is larger than each microscopic observation image by joining a plurality of microscopic observation images that correspond to different two-dimensional regions that are acquired under the control of said image capturing control means;
e) a specifying means for allowing a user to specify a desired measurement region in a specimen observation image that is displayed by said image forming means; and
f) a mass spectrometry means comprising:
an ionization means for ionizing components that are present in very small regions on the specimen;
a mass separation and detection means for separating and detecting ions that are generated according to mass/charge ratio;
a position scanning means for two-dimensionally scanning the position of said very small regions on the specimen; and
an analysis control means for controlling the ionization means, mass separation and detection means and position scanning means so as to perform a two-dimensional mass spectrometry in a measurement region specified by said specifying means.

2. The mass spectrometer according to claim 1 wherein said moving means is a means for moving, with respect to the microscopic observation means whose position is fixed, a specimen stage that holds a specimen or upon which a specimen is placed and further comprising a position data acquisition means for acquiring position data of said specimen stage when microscopic observation images are acquired under the control of said image capturing control means; and said image forming means uses position data obtained by said position data acquisition means for each microscopic observation image when joining a plurality of microscopic observation images, wherein said ionization means is performed at a predetermined position from a position where microscopic observation is performed.

3. The mass spectrometer according to claim 2 wherein said image forming means, in joining a plurality of microscopic observation images, acquires and stores specimen observation images and position data corresponding to said images; and further comprising a measurement position data acquisition means for acquiring and storing position data corresponding to measurement region based on position data that is stored by said image forming means when a measurement region is specified by said specifying means; and said analysis control means uses position data stored by said measurement position data acquisition means to control the position scanning means so as to move the specimen stage so as to scan the position of a very small region that is to be ionized by said ionization means.

4. The mass spectrometer according to claim 3 wherein: said specifying means is capable of specifying a plurality of measurement regions in a specimen observation image that is displayed; and said analysis control means controls the ionization means, mass separation and detection means and position scanning means so as to obtain position data corresponding to each of the specified plurality of measurement regions and to perform mass spectrometry in each of the measurement regions based on said position data.

5. The mass spectrometer according to any one of claims 1 through 4 wherein: said image capturing control means changes the relative position between the specimen and the microscopic observation means in a step as same as a microscopic field of vision or a smaller width step and comprehensively captures images of the entirety of a specimen placement permitted range where a specimen is allowed to be placed on the specimen stage; and
said specimen image forming means joins a plurality of microscopic observation images that are from adjacent regions or overlapping regions and are acquired by said image capturing control means to form a specimen observation image that covers the entirety of the specimen placement permitted range.
